(19) United States
(12) Patent Application Publication
(10) Pub. No.: US 2006/0117878 A1
(43) Pub. Date: Jun. 8, 2006

(54) Actuator assemblies

(76) Inventor: Nigel Victor Spurr, Birmingham (GB)

Correspondence Address: CARLSON, GASKEY & OLDS, P.C., 400 WEST MAPLE ROAD, SUITE 350, BIRMINGHAM, MI, 48009, US

(21) Appl. No.: 11/267,353

(22) Filed: Nov. 4, 2005

Related U.S. Application Data
(62) Division of application No. 09/784,466, filed on Feb. 15, 2001, now abandoned.

(30) Foreign Application Priority Data
Feb. 18, 2000 (GB) GB 0003686.3

(51) Int. Cl. F16H 21/18

(52) U.S. Cl. 74/49

(57) ABSTRACT

An actuator assembly including an actuator drivingly connected by a transmission path to an output member, the actuator being capable of moving the output member in a first direction from a rest condition to an actuated condition, and also being capable of moving the output member in a second direction from the actuated condition to the rest condition. The actuator assembly further including an energy storing means, in which movement of the output member by the actuator in the first direction is assisted by the energy storing means and movement of the output member in the second direction by the actuator stores energy in the energy storing means.

### REFERENCE TO RELATED APPLICATIONS

This application is a Divisional patent application of U.S. patent application Ser. No. 09/784,466 filed Feb. 15, 2001, which claims priority to United Kingdom Patent Application No. GB 0003686.3 filed on Feb. 18, 2000.

### BACKGROUND OF THE INVENTION

The present invention relates generally to actuator assemblies and in particular actuator assemblies used to release or latch vehicle door latches.

Known actuator assemblies when used in vehicle door latches are only required to provide an output in one direction when actuating. The actuator assembly is returned to a rest position by powering of an actuator assembly motor in a reverse direction. This return stroke does no work.

Hence, there is a need in the art for an improved actuator assembly for use to release or latch vehicle door latches.

### SUMMARY OF THE INVENTION

The present invention relates generally to an actuator assembly for use to release or latch vehicle door latches.

According to the present invention, there is provided an actuator assembly including an actuator drivingly connected by a transmission path to an output member. The actuator is capable of moving the output member in a first direction from a rest condition to an actuated condition, and is also being capable of moving the output member in a second direction from the actuated condition to the rest condition. The actuator assembly further including an energy storage means in which movement of the output member by the actuator in the first direction is assisted by the energy storage means, and the movement of the output member in the second direction by the actuator stores energy in the energy storage means.

The present invention allows the actuator assembly to produce a higher output force. Furthermore, where the transmission path includes gears, smaller gears may be used. Additionally, the actuator assembly can operate faster. Furthermore, the actuator assembly may produce the same output force with a lower powered actuator.

Accordingly, the present invention provides an actuator assembly for use to release or latch vehicle door latches.

These and other features of the present invention will be best understood from the following specification and drawings.

### BRIEF DESCRIPTION OF THE DRAWINGS

The various features and advantages of the invention will become apparent to those skilled in the art from the following detailed description of the currently preferred embodiment. The drawings that accompany the detailed description can be briefly described as follows.

FIG. 1 is a view of an actuator assembly according to the present invention.

FIG. 2 is a partial view of second embodiment of an actuator assembly according to the present invention.

FIG. 3 is a view of a third embodiment of an actuator assembly according to the present invention.

FIG. 4 is a partial view taken in the direction of arrows C of FIG. 3.

### DETAILED DESCRIPTION OF THE PREFERRED EMBODIMENT

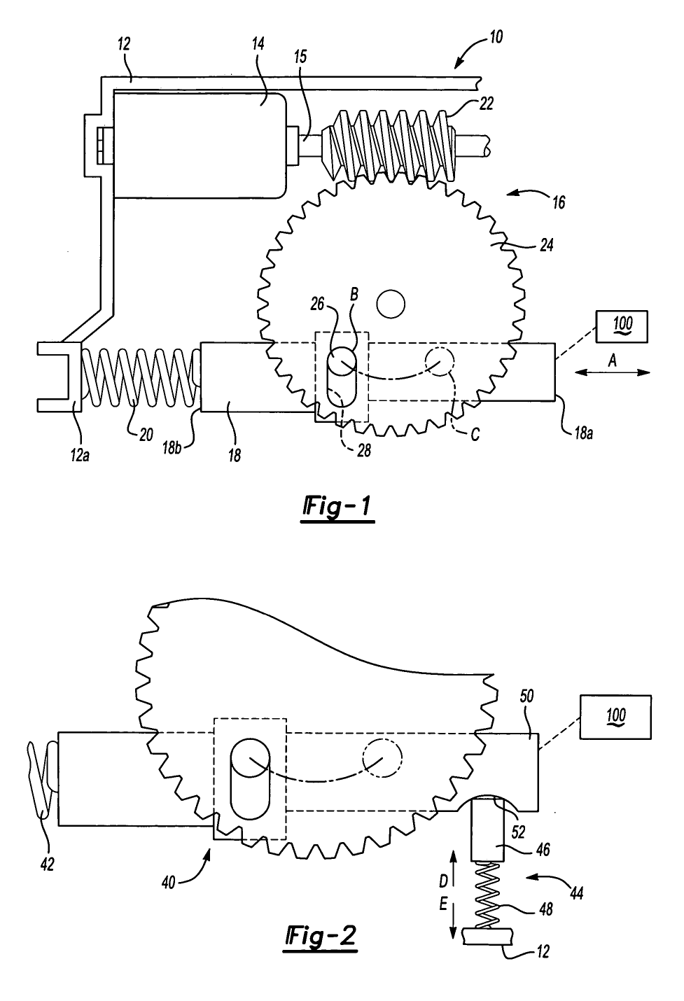

With reference to FIG. 1, there is shown an actuator assembly 10 including a housing 12, an actuator in the form of an electric motor 14, a transmission path 16, an output member 18, and an energy storage means in the form of a compression spring 20.

The transmission path 16 includes a worm gear 22 which engages a worm wheel 24. Worm gear 22 is mounted rotationally fast on motor shaft 15. Worm wheel 24 is rotationally mounted on the housing 12 and includes a crank pin 26, which engages in a lateral slot 28 of output member 18.

Output member 18 is guided by guides for reciprocating linear movement in the direction of arrow A. Output member 18 has an output abutment 18A at one end thereof and a spring abutment 18B at the other end thereof. Spring 20 is mounted between a portion 12A of housing 12 and spring abutment 18B of the output member 18.

FIG. 1 shows the actuator assembly in an at rest position with spring 20 having being compressed. Thus spring 20 biases the output member 18 to the right as shown in FIG. 1, the bias load being resisted by the crank pin 26. The helix angle of the teeth of the worm gear 22 and worm wheel 24, combined with the various frictional loses in the transmission path result in the bias load (spring force) provided by compressed spring 20 being unable to back drive motor 14, i.e. turn motor 14. The actuator assembly 10 thus remains in its at rest position shown in FIG. 1.

When actuation is required, an electrical current is supplied to motor 14, resulting in shaft 15 rotating and ultimately in worm wheel 24 rotating in a counter-clockwise direction. This results in the crank pin 26 moving from position B to position C. This results in output abutment 18A contacting and moving further components to, for example, release or latch an associated vehicle door latch 100. The spring 20 assists in the moving of the output member 18 to the right.

Once actuation has occurred, an electrical current is fed to the motor 14 causing it to run in a reverse direction resulting in the crank pin 26 moving from position C to position B, thus returning the output member 18 to its at rest position. It should be noted that during the movement of the output member 18 from its actuated position to its at rest position, spring 20 is caused to compress.

Thus when the actuator assembly 10 is moving from its at rest position to its actuated position, the spring 20 is releasing energy previously stored and acts to assist the motor 14. When the actuator assembly 10 moves from its actuated position to its rest position, the motor 14 acts to compress the spring 20, storing energy therein.

Once the reversing current to motor 14 has stopped, the actuator assembly 10 remains in a position as shown in FIG. 1 by virtue of the fact that spring 20, which has now been compressed, is attempting to back drive motor 14 via the worm wheel 24 and worm gear 22. Typically, the worm wheel 24 and worm gear 22 would be 60% efficient and thus the various frictional loses associated with the sliding output member 18, the worm wheel 24 and worm gear 22, and the motor 14 are sufficient to ensure that the actuator assembly 10 remains in the position as shown in FIG. 1 even when no power is supplied to motor 14.

With reference to FIG. 2, there is shown a second embodiment of an actuator assembly 40. In this embodiment, the spring 42 has a higher spring rate, and the actuator assembly 40 further includes a detent arrangement 44. The detent arrangement 44 includes a plunger 46 which is biased in the direction of arrow D by spring 48. Output member 50 includes a detent notch 52 into which plunger 46 can engage. When the actuator assembly 40 is in its at rest position, as illustrated in FIG. 2, plunger 46 engages detent notch 52 and acts to realeasably retain the actuator assembly 40 in its at rest position.

When the actuator assembly 40 is required to actuate, the motor 14 is arranged such that it can, in conjunction with the increased load provided by spring 42, overcome the retaining action of the detent 44, following which the actuator assembly 40 can produce a higher actuating output force as a result of the greater force provided by spring 42.

In this embodiment, the output member 50 is linearly moveable and the detent arrangement 44 acts substantially perpendicularly to the direction of movement of the output member 50. In further embodiments, the output member 50 could move in a rotational direction and a detent arrangement 44 could act substantially perpendicularly to this rotational direction, i.e. radially inwardly or radially outwardly.

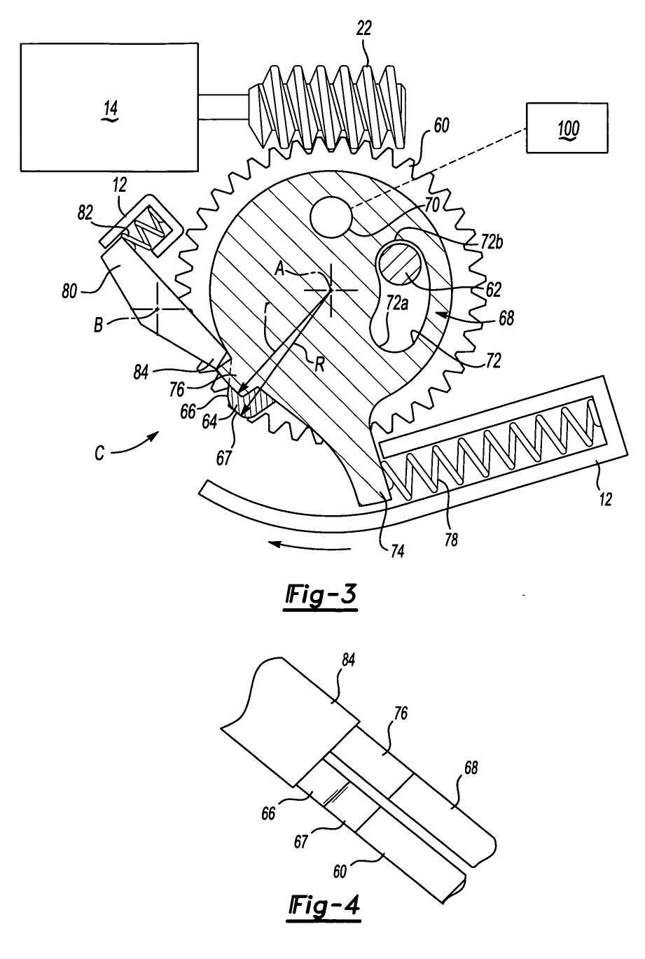

In another embodiment, as illustrated in FIG. 3, a clutch arrangement can be utilized to ensure that the actuator assembly remains in its at rest condition. The motor 14 is connected to worm wheel 60 which is rotatably mounted about axis A. Worm wheel 60 includes a drive pin 62 secured thereto and a stop pawl disengaging ramp 64 also secured thereto having a ramp surface 66 and a radially outer surface 67.

Also pivotally mounted about axis A is an output lever shown generally at arrow 68. Output lever 68 includes an output pin 70, an arcuate slot 72 within which drive pin 62 sits, and assist spring abutment 74 and stop abutment 76. An assist spring 78 acts on assist spring abutment 74 and reacts against housing 12. Assist spring 78 biases the output lever 68 in a clockwise direction when viewing FIG. 3.

An output lever stop pawl 80 is pivotally mounted about axis B and is biased in a counter clockwise direction by a spring 82 which reacts against housing 12. Pawl end 84 is provided for contact with stop abutment 76. As illustrated in FIG. 3, the actuator assembly is positioned in its rest position. The assist spring 78 has been compressed and the output lever 68 is prevented from being rotated in a clockwise direction under the influence of assist spring 78 by abutment of stop abutment 76 against pawl end 84.

Actuation of motor 14 causes worm gear 22 to rotate such that worm wheel 60 is caused to rotate in a clockwise direction. Because of the arcuate slot 72, initially, drive pin 62 does not drive the output lever 68. However, as the worm wheel 60 rotates in a clockwise direction, the ramp surface 66 of stop pawl disengagement ramp 64 acts on pawl end 84 to cam that end radially outward relative to axis A. As illustrated in FIG. 4, pawl end 84 is wide enough to be acted upon by both stop abutments 76 and stop pawl disengagement ramp 64. This causes pawl 80 to rotate in a clockwise direction until such time as the pawl end 84 contacts the radially outer surface 67 of disengagement ramp 64. It should be noted that the radially outer surface 67 is positioned at a distance R from axis A which is greater than the outer most portion of stop abutment 76, positioned at a radius r from axis A. Thus, the stop pawl disengagement ramp 64 causes the stop pawl 80 to disengage from the stop abutment 76, allowing the output lever 68 to rotate in a clockwise direction under the influence of assist spring 78 and drive pin 62 as it contacts end 72A of the arcuate slot 72. This results in actuation of the components connected to output pin 70 since this pin 70 moves from the position as shown in FIG. 3 clockwise for actuation.

Once actuation has being achieved, the motor 14 is powered in the reverse direction causing drive pin 62 to contact end 72B of the slot 72, which results in compression of the assist spring 78 and ultimately re-engagement of pawl end 84 against stop abutment 76 once stop abutment 76 has being rotated past pawl end 84.

In this case, since the output lever 68 is positively retained in its at rest position by pawl 80, the load in assist spring 78 when the actuator is in its at rest position is limited only by the ability of the motor 14 to compress spring 78 to its at rest position, and not by the friction developed in the transmission parts from the output lever 68 to the motor. It can been seen that the arrangement shown in FIG. 3 provides for a clutch arrangement for ensuring that the actuator remains in its at rest position.

In further embodiments, clutch arrangements can be used on output members which act in a linear direction as opposed to a rotational direction.

It can be seen that the friction within a transmission path 16, the detent arrangement 44, and the clutch arrangement each act as a retaining arrangement which releasably retain the actuator assembly 10, 40 in its at rest condition against the influence of the energy storage device such as springs 20, 42 and 78.

The foregoing description is only exemplary of the principles of the invention. Many modifications and variations of the present invention are possible in light of the above teachings. The preferred embodiments of this invention have been disclosed, however, so that one of ordinary skill in the art would recognize that certain modifications would come within the scope of this invention. It is, therefore, to be understood that within the scope of the appended claims, the invention may be practiced otherwise than as specially described. For that reason the following claims should be studied to determine the true scope and content of this invention.

1-23. (canceled)

24. An actuator assembly comprising:
an actuator drivingly connected by a transmission path to an output member, said actuator being operable to apply a force in a first direction to drive said output member in said first direction from a rest condition to an actuated condition, and said actuator also being operable to apply a force in a second direction to drive said output member in said second direction from said actuated condition to said rest condition; and
an energy storing member, wherein movement of said output member by said actuator in said first direction is assisted by said energy storing member and movement of said output member by said actuator in said second direction stores energy in said energy storing member, wherein the movement of said output member in said first direction and said second direction is rotational.

25. The actuator assembly as recited in claim 24 wherein said actuator is operably connected to said energy storing member by at least a portion of said transmission path.

26. The actuator assembly as recited in claim 24 wherein said actuator assembly further comprises a retaining arrangement to releasably retain said actuator assembly in said rest condition.

27. The actuator assembly as recited in claim 26 wherein said retaining arrangement is partially provided by friction associated with at least one of said actuator, said transmission path and said output member.

28. The actuator assembly as recited in claim 26 wherein said retaining arrangement is provided by a detent arrangement.

29. The actuator assembly as recited in claim 28 wherein said detent arrangement acts upon said output member.

30. The actuator assembly as recited in claim 29 wherein said detent arrangement acts substantially perpendicularly to a direction of movement of said output member.

31. The actuator assembly as recited in claim 26 wherein said retaining arrangement is a clutch arrangement.

32. The actuator assembly as recited in claim 31 wherein said clutch arrangement includes a pawl acting on said output member.

33. The actuator assembly as recited in claim 32 wherein said pawl is disengaged from said output member by a pawl disengagement ramp, said pawl disengagement ramp being a component of said transmission path.

34. The actuator assembly as recited in claim 33 wherein said component of said transmission path has a lost motion connection on said output member.

35. The actuator as recited in claim 31 wherein said transmission path includes a worm gear and a worm wheel.

36. The actuator arrangement as recited in claim 35 wherein said actuator is operably connected to said energy storing member by said worm gear and said worm wheel.

37. The actuator assembly as recited in claim 36 wherein said worm wheel includes a crank pin acting on said output member.

38. The actuator assembly as recited in claim 24 wherein said energy storing member acts on said output member.

39. The actuator assembly as recited in claim 24 wherein said energy storing member is a resilient member.

40. The actuator assembly as recited in claim 39 wherein said resilient member is a spring.

41. The actuator assembly as recited in claim 24 wherein said actuator assembly further comprises a housing which at least partially contains said actuator, said transmission path and said output member.

42. A method of operating an actuator assembly having an actuator, an output member, and an energy storing member, the method comprising the steps of:
driving the actuator to apply a force in a first direction to drive the output member in a first rotational direction from a rest condition to an actuated condition;
applying a stored energy force from the energy storing member in the first direction to assist the actuator in driving the output member in the first rotational direction;
driving the actuator to apply a force in a second direction to drive the output member in a second rotational direction from the actuated condition to the rest condition; and
storing energy in the energy storing member when the actuator applies the force in the second direction.

43. A vehicle door latch comprising:
an actuator assembly including:
an actuator drivingly connected by a transmission path to an output member, said actuator being operable to apply a force in a first direction to drive said output member in said first direction from a rest condition to an actuated condition, and said actuator also being operable to apply a force in a second direction to drive said output member in said second direction from said actuated condition to said rest condition; and
an energy storing member, wherein movement of said output member by said actuator in said first direction is assisted by said energy storing member and movement of said output member by said actuator in said second direction stores energy in said energy storing member, wherein the movement of said output member in said first direction and said second direction is rotational.

44. The vehicle door latch as recited in claim 43 wherein the movement of said output member in said first direction releases the vehicle door latch.

45. The vehicle door latch as recited in claim 43 wherein the movement of said output member in said first direction latches the vehicle door latch.
